(19) United States
(12) Patent Application Publication
(10) Pub. No.: US 2013/0050171 A1
(43) Pub. Date: Feb. 28, 2013

(54) LIQUID CRYSTAL DISPLAY WHICH CAN COMPENSATE GATE VOLTAGES AND METHOD THEREOF

(71) Applicant: Ming-Han Tsai, Taipei City (TW)

(72) Inventor: Ming-Han Tsai, Taipei City (TW)

(21) Appl. No.: 13/279,339

(22) Filed: Oct. 24, 2011

(30) Foreign Application Priority Data
Aug. 22, 2011 (TW) 100130025

(51) Int. Cl. G09G 3/36; G09G 5/00

(52) U.S. Cl. 345/212; 345/87

(57) ABSTRACT

A method of compensating gate voltages of a liquid crystal display includes generating a first high gate voltage, a second high gate voltage, and a first low gate voltage; generating a first scan start signal and a reference clock; generating and outputting a second scan start signal, a first clock, a second clock, a third clock, a fourth clock, and the first low gate voltage according to the first high gate voltage, the second high gate voltage, the first low gate voltage, the first scan start signal, and the reference clock; driving a plurality of pixels included by a liquid crystal panel according to the second scan start signal, the first clock, the second clock, the third clock, the fourth clock, and the first low gate voltage to improve frame quality displayed by the liquid crystal panel.

### BACKGROUND OF THE INVENTION

1. Field of the Invention

The present invention is related to a liquid crystal display and method thereof, and particularly to a liquid crystal display which can compensate gate voltages and method thereof.

2. Description of the Prior Art

Please refer to FIG. 1, FIG. 2A, and FIG. 2B. FIG. 1 is a diagram illustrating pixels of a dual-gate liquid crystal display, FIG. 2A is a diagram illustrating a gate driving circuit having two opposite phases and the same frequency clock groups according to the prior art, and FIG. 2B is a diagram illustrating an operation timing of the gate driving circuit in FIG. 2A. As shown in FIG. 1, because a row of pixels of the liquid crystal panel corresponds to two gate lines, number of gate lines of the pixels of the dual-gate liquid crystal display is two times number of gate lines of pixels of a single-gate liquid crystal display, and the gate lines of the dual-gate liquid crystal display are driven by the two opposite phases and the same frequency clock groups. As shown in FIG. 2A, gate driving units G1, G3, G5 . . . of the gate driving circuit correspond to one opposite phase and the same frequency clock group CK1, CKB1 of the two opposite phase and the same frequency clock groups, and gate driving units G2, G4 . . . of the gate driving circuit correspond to the other opposite phase and the same frequency clock group CK2, CKB2 of the two opposite phases and the same frequency clock groups. In addition, the gate driving units G1, G2, G3, G4, G5 . . . drive the pixels of the dual-gate liquid crystal panel through gate lines GL1, GL2, GL3, GL4, GL5 . . . , where STV1 is a scan start signal corresponding to the gate driving units G1, G3, G5 . . . , and STV2 is a scan start signal corresponding to the gate driving units G2, G4 . . . As shown in FIG. 2B, a turning-on interval of a gate line partially overlaps a turning-on interval of a previous gate line. Therefore, when a thin film transistor is turned on according to a voltage of a corresponding gate line, data of a previous pixel is written to a pixel corresponding to the thin film transistor in a front half of a turning-on interval of the thin film transistor (diagonal area in FIG. 2B), and data corresponding to the pixel is written to the pixel corresponding to the thin film transistor in a back half of the turning-on interval of the thin film transistor, where D1, D2, D3, D4, D5 are data voltages outputted by a source driving circuit.

Please refer to FIG. 3A and FIG. 3B. FIG. 3A is a diagram illustrating a charged condition of a pixel when the pixel is written a datum with a polarity that is opposite to a polarity corresponding to the pixel in a front half of a turning-on interval of a thin film transistor, and FIG. 3B is a diagram illustrating a charged condition of a pixel when the pixel is written a datum with a polarity that is the same polarity corresponding to the pixel in a front half of a turning-on interval of a thin film transistor. As shown in FIG. 3A and FIG. 3B, a pixel voltage level in FIG. 3A is lower than a pixel voltage level in FIG. 3B. That is to say, luminance of a pixel in FIG. 3A is lower than luminance of a pixel in FIG. 3B. Please refer to FIG. 4A and FIG. 4B. FIG. 4A is a diagram illustrating pixels of a 2-line inversion dual-gate thin film liquid crystal display being driven in a Z-type sequence, and FIG. 4B is a diagram illustrating pixels of a 2-line inversion dual-gate thin film liquid crystal display being driven in a curved line sequence, resembling the letter “S”, where (+), (−) represent polarities of the pixels. As shown in FIG. 4A, luminance of odd column pixels is lower than luminance of even column pixels, so the dual-gate thin film liquid crystal display shows a strip pattern. As shown in FIG. 4B, although the curved line sequence resembling the letter “S” can relieve the strip pattern of the dual-gate thin film liquid crystal display, the curved line sequence resembling the letter “S” does not completely solve different charge conditions of the pixels of the dual-gate thin film liquid crystal display. Therefore, when the dual-gate thin film liquid crystal display is located in a harsh environment (such as a low temperature environment or a high frequency environment), the dual-gate thin film liquid crystal display may display bad frames with a light and dark cross checkerboard pattern, resulting in frame quality displayed by the dual-gate thin film liquid crystal display being degraded.

### SUMMARY OF THE INVENTION

An embodiment provides a liquid crystal display which can compensate gate voltages. The liquid crystal display includes direct current (DC) voltage generation circuit, a timing controller, a clock generation circuit, and a liquid crystal panel. The DC voltage generation circuit is used for generating a first high gate voltage, a second high gate voltage, and a first low gate voltage, where the first high gate voltage is higher than the second high gate voltage. The timing controller is used for generating a first scan start signal and a reference clock. The clock generation circuit is coupled between the DC voltage generation circuit and the timing controller for generating and outputting a second scan start signal, a first clock, a second clock, a third clock, a fourth clock, and the first low gate voltage according to the first high gate voltage, the second high gate voltage, the first low gate voltage, the first scan start signal, and the reference clock. The liquid crystal panel includes a plurality of pixels and a gate driving circuit. The gate driving circuit is coupled to the clock generation circuit. The gate driving circuit includes a plurality of gate driving units, wherein the plurality of gate driving units is used for driving the plurality of pixels according to the second scan start signal, the first clock, the second clock, the third clock, the fourth clock, and the first low gate voltage to improve frame quality displayed by the liquid crystal panel. A phase of the first clock is opposite a phase of the third clock, and a phase of the second clock is opposite a phase of the fourth clock. A (4n+1)^{th} gate driving unit of the plurality of gate driving units receives the first clock, a (4n+2)^{th} gate driving unit of the plurality of gate driving units receives the second clock, a (4n+3)^{th} gate driving unit of the plurality of gate driving units receives the third clock, and a (4n+4)^{th} gate driving unit of the plurality of gate driving units receives the fourth clock, wherein n≧0 and n is an integer.

Another embodiment provides a method of compensating gate voltages of a liquid crystal display. The method includes a DC voltage generation circuit generating a first high gate voltage, a second high gate voltage, and a first low gate voltage, where the first high gate voltage is higher than the second high gate voltage; a timing controller generating a first scan start signal and a reference clock; a clock generation circuit generating and outputting a second scan start signal, a first clock, a second clock, a third clock, a fourth clock, and the first low gate voltage according to the first high gate voltage, the second high gate voltage, the first low gate voltage, the first scan start signal, and the reference clock; and driving a plurality of pixels included by a liquid crystal panel to improve frame quality displayed by the liquid crystal panel according to the second scan start signal, the first clock, the second clock, the third clock, the fourth clock, and the first low gate voltage, wherein a phase of the first clock is opposite a phase of the third clock, and a phase of the second clock is opposite a phase of the fourth clock. A (4n+1)^{th} gate driving unit of the plurality of gate driving units of the liquid crystal panel receives the first clock, a (4n+2)^{th} gate driving unit of the plurality of gate driving units receives the second clock, a (4n+3)^{th} gate driving unit of the plurality of gate driving units receives the third clock, and a (4n+4)^{th} gate driving unit of the plurality of gate driving units receives the fourth clock, wherein n≧0 and n is an integer.

The present invention provides a liquid crystal display which can compensate gate voltages and method thereof. The liquid crystal display and the method utilize different high gate voltages to solve uneven charged conditions of a plurality of pixels of the liquid crystal panel. Compared to the prior art, because differences of charged conditions of the plurality of pixels of the liquid crystal panel are smaller, the present invention can improve frame quality displayed by the liquid crystal panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating pixels of a dual-gate liquid crystal display.

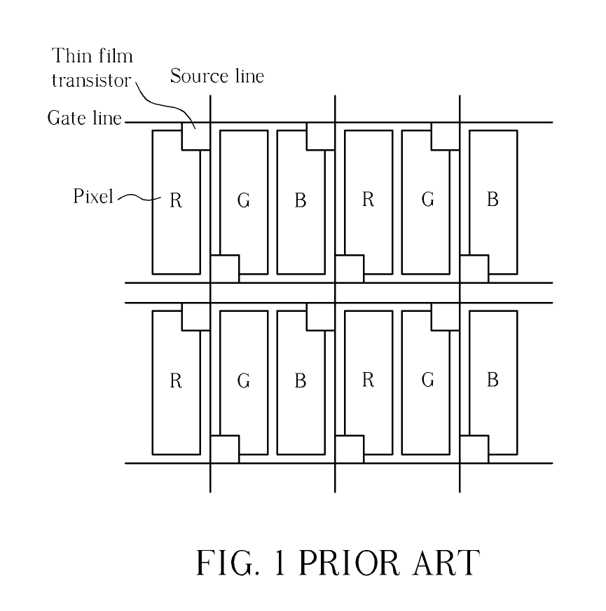

FIG. 2A is a diagram illustrating a gate driving circuit having two opposite phase and the same frequency clock groups according to the prior art.

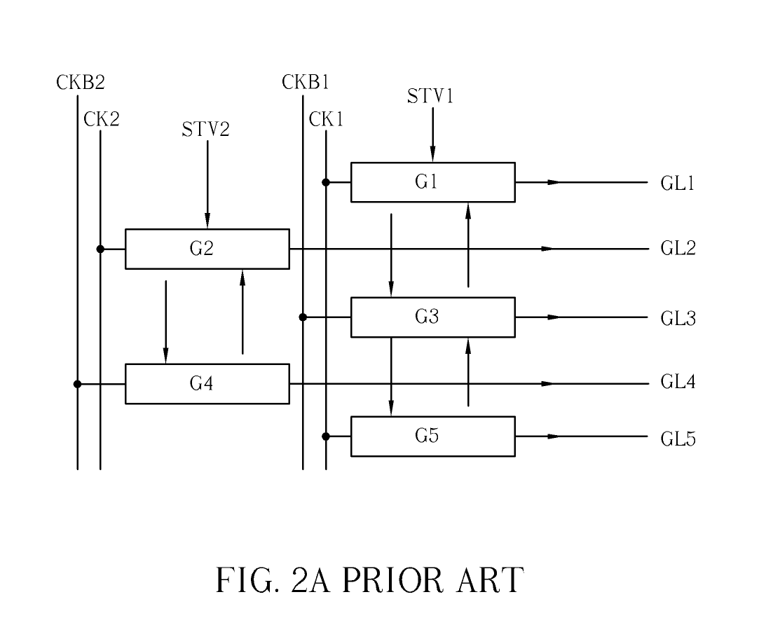

FIG. 2B is diagram illustrating an operation timing of the gate driving circuit in FIG. 2A.

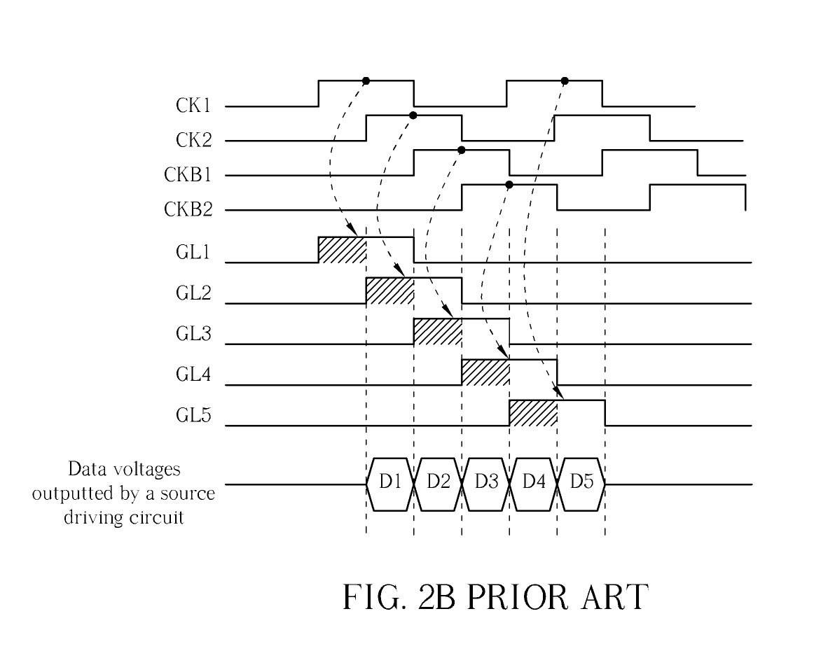

FIG. 3A is a diagram illustrating a charged condition of a pixel when the pixel is written data whose polarity is opposite a polarity of data corresponding to the pixel in a front half of a turning-on interval of a thin film transistor.

FIG. 3B is a diagram illustrating a charged condition of a pixel when the pixel is written data whose polarity is the same as a polarity of data corresponding to the pixel in a front half of a turning-on interval of a thin film transistor.

FIG. 4A is a diagram illustrating pixels of a 2-line inversion dual-gate thin film liquid crystal display being driven in a Z-type sequence.

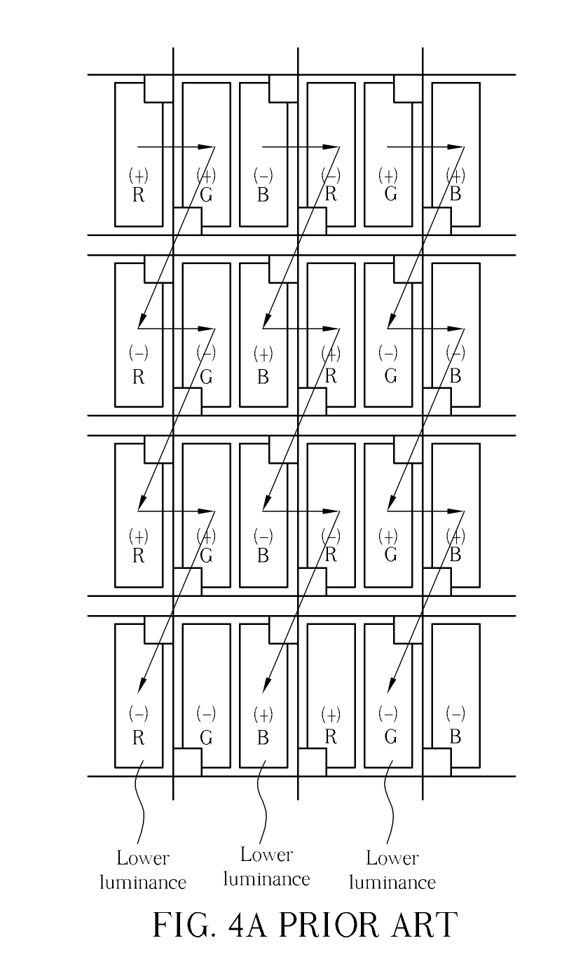

FIG. 4B is a diagram illustrating pixels of a 2-line inversion dual-gate thin film liquid crystal display being driven in a curved line sequence like as the letter “S”.

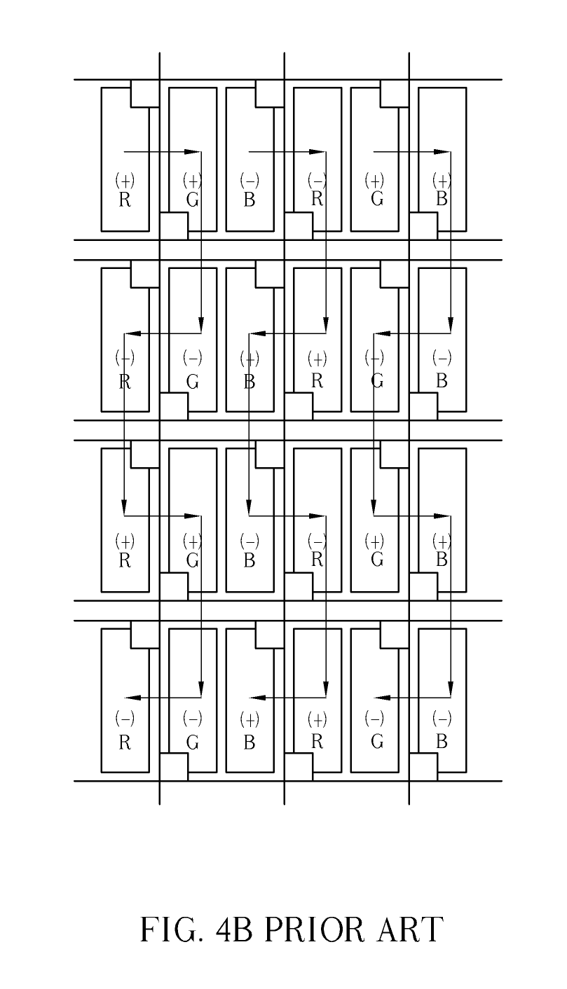

FIG. 5 is a diagram illustrating a liquid crystal display 500 which can compensate gate voltages according to an embodiment.

FIG. 6A is a diagram illustrating the first clock, the second clock, the third clock, and the fourth clock.

FIG. 6B is a diagram illustrating the (4n+1)^{th} gate driving unit of the plurality of gate driving units receiving the first clock, the (4n+2)^{th} gate driving unit of the plurality of gate driving units receiving the second clock, the (4n+3)^{th} gate driving unit of the plurality of gate driving units receiving the third clock, and the (4n+4)^{th} gate driving unit of the plurality of gate driving units receiving the fourth clock.

FIG. 7A is a diagram illustrating a pixel having a data polarity the same as a data polarity of a previous pixel being charged.

FIG. 7B is a diagram illustrating a pixel having a data polarity opposite a data polarity of a previous pixel being charged.

FIG. 8A is a diagram illustrating a liquid crystal display which can compensate gate voltages according to another embodiment.

FIG. 8B is a diagram illustrating a first clock, a second clock, a third clock, and a fourth clock of the liquid crystal display.

FIG. 9A is a diagram illustrating a first clock, a second clock, a third clock, and a fourth clock of a 1+2-line inversion liquid crystal display according to another embodiment.

FIG. 9B is a diagram illustrating pixel arrangement of the 1+2-line inversion liquid crystal display.

FIG. 10A is a diagram illustrating a first clock, a second clock, a third clock, and a fourth clock of a 4-line inversion liquid crystal display according to another embodiment.

FIG. 10B is a diagram illustrating pixel arrangement of the 4-line inversion liquid crystal display.

FIG. 11 is a flowchart illustrating a method of compensating gate voltages of a liquid crystal display according to another embodiment.

FIG. 12 is a flowchart illustrating a method of compensating gate voltages of a liquid crystal display according to another embodiment.

### DETAILED DESCRIPTION

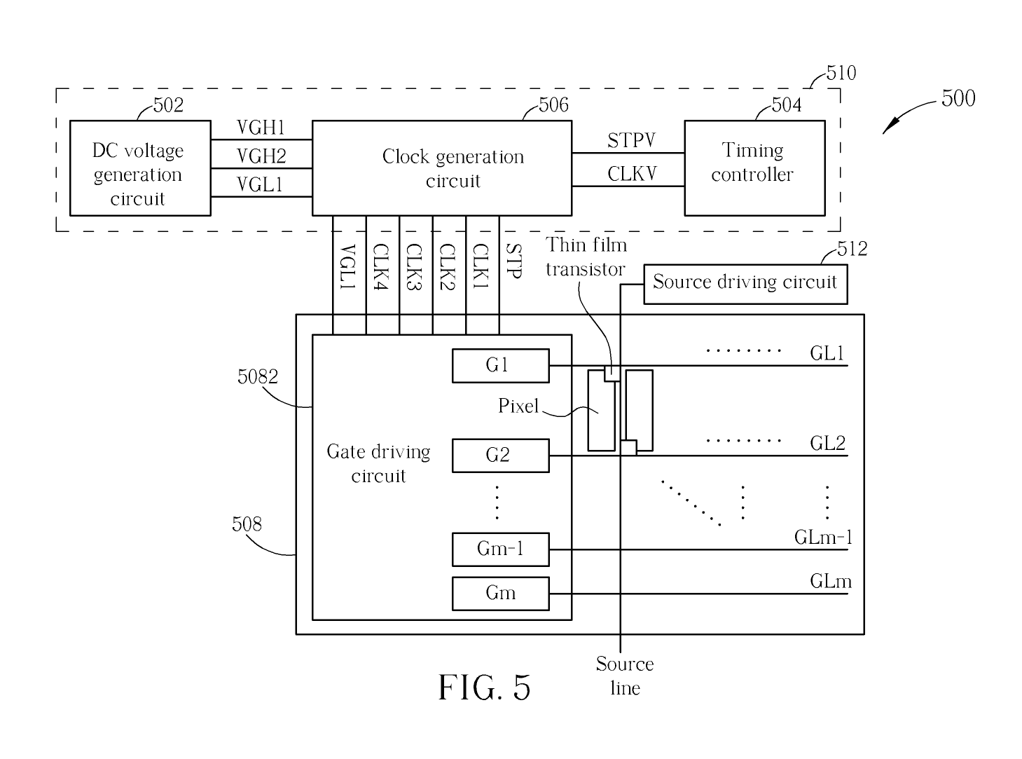

Please refer to FIG. 5. FIG. 5 is a diagram illustrating a liquid crystal display 500 which can compensate gate voltages according to an embodiment, where the liquid crystal display 500 is a 2-line inversion liquid crystal display. The liquid crystal display 500 includes a direct current (DC) voltage generation circuit 502, a timing controller 504, a clock generation circuit 506, and a liquid crystal panel 508. The DC voltage generation circuit 502, the timing controller 504, and the clock generation circuit 506 are located on a printed circuit board 510. The DC voltage generation circuit 502 is used for generating a first high gate voltage VGH1, a second high gate voltage VGH2, and a first low gate voltage VGL1, where the first high gate voltage VGH1 is higher than the second high gate voltage VGH2. The timing controller 504 is used for generating a first scan start signal STPV and a reference clock CLKV. The clock generation circuit 506 is coupled between the DC voltage generation circuit 502 and the timing controller 504 for generating and outputting a second scan start signal STP, a first clock CLK1, a second clock CLK2, a third clock CLK3, a fourth clock CLK4, and the first low gate voltage VGL1 according to the first high gate voltage VGH1, the second high gate voltage VGH2, the first low gate voltage VGL1, the first scan start signal STPV, and the reference clock CLKV. A phase of the first clock CLK1 is opposite a phase of the third clock CLK3, and a phase of the second clock CLK2 is opposite a phase of the fourth clock CLK4 The liquid crystal panel 508 includes a plurality of pixels and a gate driving circuit 5082. The gate driving circuit 5082 is coupled to the clock generation circuit 506. The gate driving circuit 5082 includes a plurality of gate driving units G1 to Gm, where the plurality of gate driving units G1 to Gm is used for driving the plurality of pixels of the liquid crystal panel 508 through gate lines GL1 to GLm according to the second scan start signal STP, the first clock CLK1, the second clock CLK2, the third clock CLK3, the fourth clock CLK4, and the first low gate voltage VGL1 to improve frame quality displayed by the liquid crystal panel 508, and m is an integer greater than 1. In addition, a (4n+1)^{th} gate driving unit of the plurality of gate driving units G1 to Gm receives the first clock CLK1, a (4n+2)^{th} gate driving unit of the plurality of gate driving units G1 to Gm receives the second clock CLK2, a (4n+3)^{th} gate driving unit of the plurality of gate driving units G1 to Gm receives the third clock CLK3, and a (4n+4)^{th} gate driving unit of the plurality of gate driving units G1 to Gm receives the fourth clock CLk4, where n≧0, n is an integer, m>n, and m≧4n+4. In addition, the liquid crystal display 500 further includes a source driving circuit 512 used for charging a pixel through a corresponding source line when a thin film transistor coupled to the pixel is turned on.

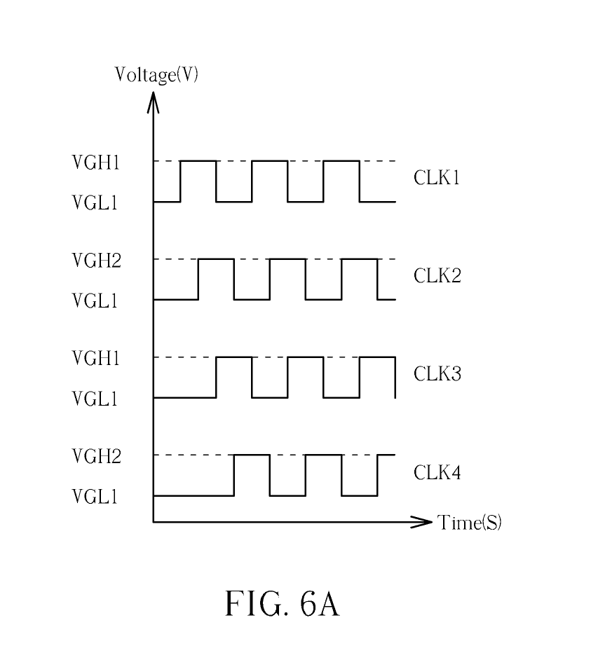

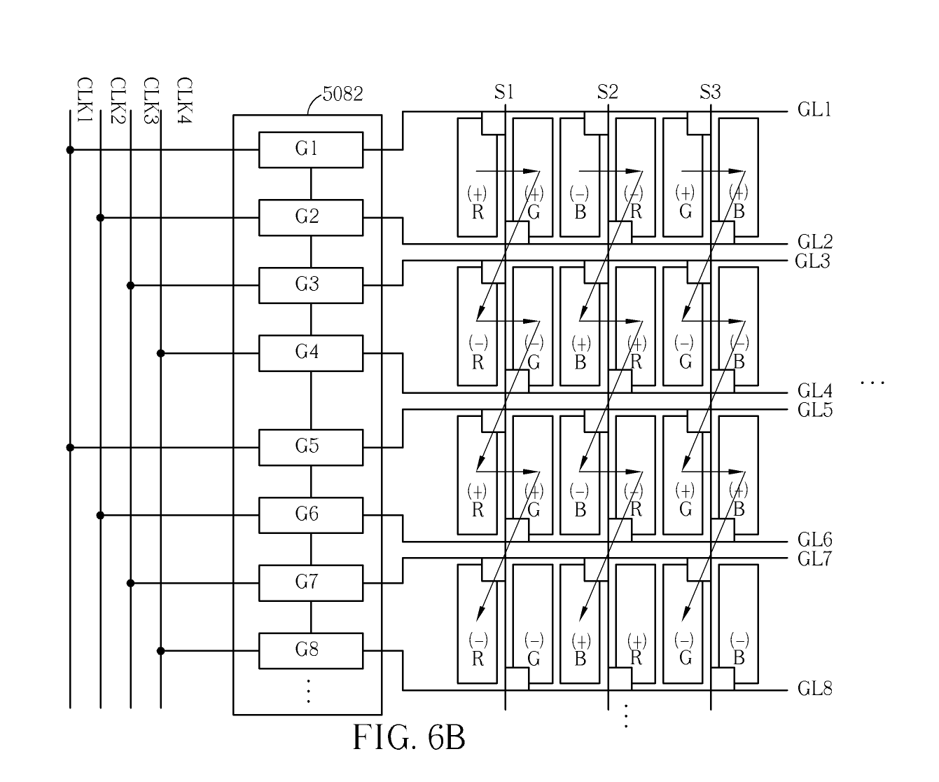

Please refer to FIG. 6A and FIG. 6B. FIG. 6A is a diagram illustrating the first clock CLK1, the second clock CLK2, the third clock CLK3, and the fourth clock CLK4, and FIG. 6B is a diagram illustrating the (4n+1)^{th} gate driving unit of the plurality of gate driving units G1 to Gm receiving the first clock CLK1, the (4n+2)^{th} gate driving unit of the plurality of gate driving units G1 to Gm receiving the second clock CLK2, the (4n+3)^{th} gate driving unit of the plurality of gate driving units G1 to Gm receiving the third clock CLK3, and the (4n+4)^{th} gate driving unit of the plurality of gate driving units G1 to Gm receiving the fourth clock CLk4. As shown in FIG. 6B, (+) and (−) represent polarities of the plurality of pixels, the gate driving circuit 5082 drives the plurality of pixels in a Z-type sequence, and S1, S2, and S3 are source lines. As shown in FIG. 6A, the phase of the first clock CLK1 is opposite the phase of the third clock CLK3, and the phase of the second clock CLK2 is opposite the phase of the fourth clock CLK4. In addition, high voltage levels of the second clock CLK2 and the fourth clock CLK4 are the second high gate voltage VGH2, high voltage levels of the first clock CLK1 and the third clock CLK3 are the first high gate voltage VGH1, and low voltage levels of the first clock CLK1, the second clock CLK2, the third clock CLK3, and the fourth clock CLK4 are the first low gate voltage VGL1. As shown in FIG. 6B, a polarity of a pixel opposite a polarity of a previous pixel corresponds to the gate driving units G1, G3, G5 . . . , and a polarity of a pixel the same as a polarity of a previous pixel corresponds to the gate driving units G2, G4, G6 . . . . Therefore, the gate driving units G1, G5, G9 . . . correspond to the first clock CLK1, the gate driving units G3, G7, G11 . . . correspond to the third clock CLK3, the gate driving units G2, G6, G10 . . . correspond to the second clock CLK2, and the gate driving units G4, G8, G12 . . . correspond to the fourth clock CLK4.

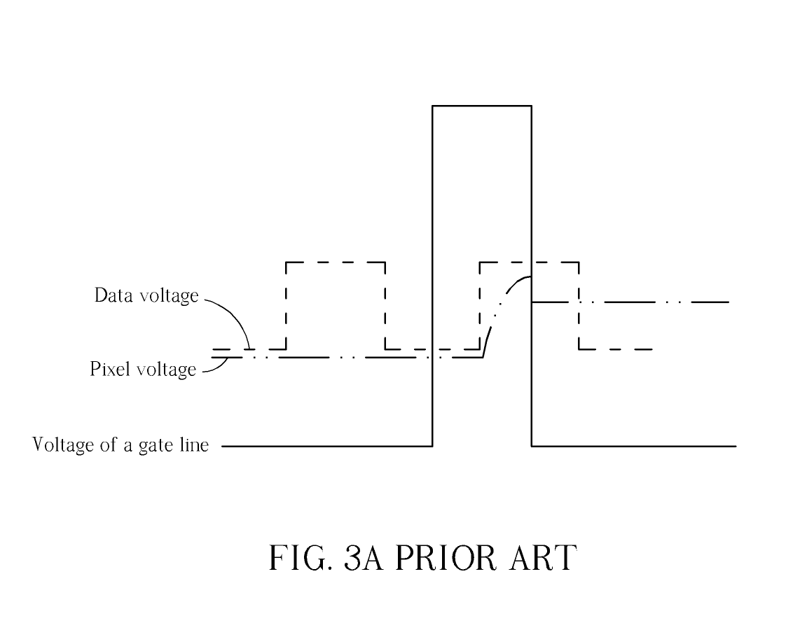

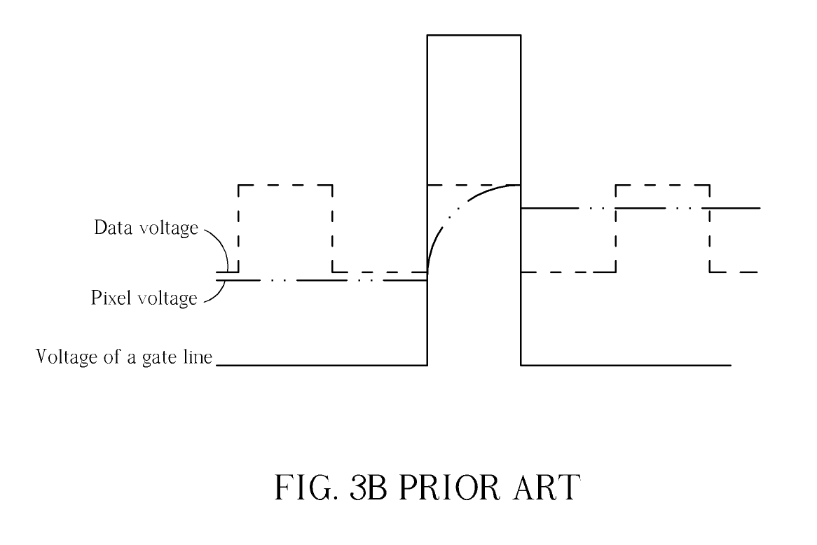

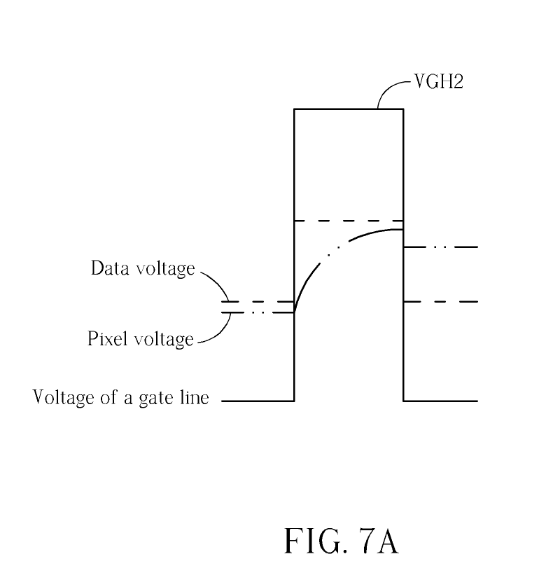

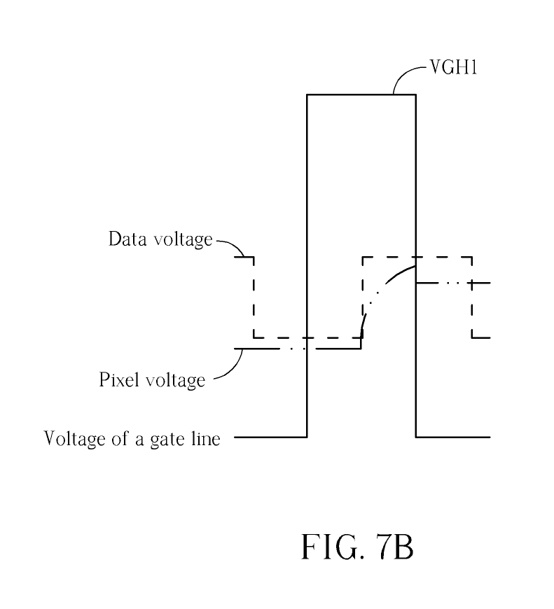

Please refer to FIG. 7A and FIG. 7B. FIG. 7A is a diagram illustrating a pixel having a data polarity the same as a data polarity of a previous pixel being charged, and FIG. 7B is a diagram illustrating a pixel having a data polarity opposite a data polarity of a previous pixel being charged. As shown in FIG. 7A and FIG. 7B, because the first high gate voltage VGH1 is higher than the second high gate voltage VGH2, a difference between a charged condition of a pixel in FIG. 7A and a charged condition of a pixel in FIG. 7B is smaller than a difference between the charged condition of the pixel in FIG. 3A and the charged condition of the pixel in FIG. 3B.

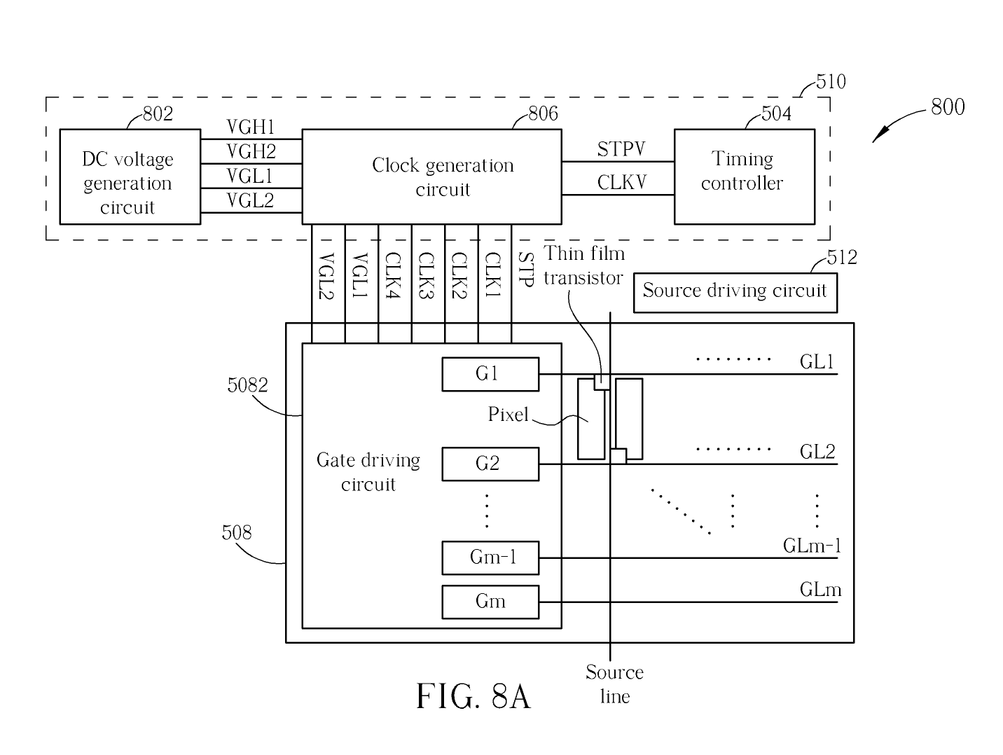

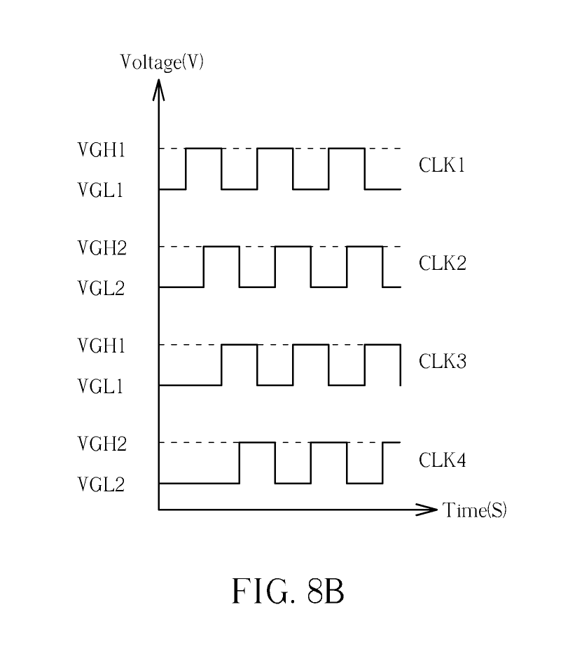

Please refer to FIG. 8A and FIG. 8B. FIG. 8A is a diagram illustrating a liquid crystal display 800 which can compensate gate voltages according to another embodiment, and FIG. 8B is a diagram illustrating a first clock CLK1, a second clock CLK2, a third clock CLK3, and a fourth clock CLK4 of the liquid crystal display 800, where the liquid crystal display 800 is a 2-line inversion liquid crystal display. A difference between the liquid crystal display 800 and the liquid crystal display 500 is that a DC voltage generation circuit 802 further generates a second low gate voltage VGL2 to a clock generation circuit 806. The clock generation circuit 806 generates and outputs a second scan start signal STP, the first clock CLK1, the second clock CLK2, the third clock CLK3, the fourth clock CLK4, the first low gate voltage VGL1, and the second low gate voltage VGL2 according to a first high gate voltage VGH1, a second high gate voltage VGH2, a first low gate voltage VGL1, the second low gate voltage VGL2, a first scan start signal STPV, and a reference clock CLKV. The gate driving circuit 5082 drives the plurality of pixels of the liquid crystal panel 508 according to the second scan start signal STP, the first clock CLK1, the second clock CLK2, the third clock CLK3, the fourth clock CLK4, the first low gate voltage VGL1, and the second low gate voltage VGL2, where the first low gate voltage VGL1 is higher than the second low gate voltage VGL2. Therefore, as shown in FIG. 8B, high voltage levels of the second clock CLK2 and the fourth clock CLK4 are the second high gate voltage VGH2, high voltage levels of the first clock CLK1 and the third clock CLK3 are the first high gate voltage VGH1, low voltage levels of the second clock CLK2 and the fourth clock CLK4 are the second low gate voltage VGL2, and low voltage levels of the first clock CLK1 and the third clock CLK3 are the first low gate voltage VGL1. Thus, a difference between the high voltage level and the low voltage level of the first clock CLK1, a difference between the high voltage level and the low voltage level of the second clock CLK2, a difference between the high voltage level and the low voltage level of the third clock CLK3, and a difference between the high voltage level and the low voltage level of the fourth clock CLK4 are the same. In the liquid crystal display 800, compared to the prior art, because the difference between the high voltage level and the low voltage level of the first clock CLK1, the difference between the high voltage level and the low voltage level of the second clock CLK2, the difference between the high voltage level and the low voltage level of the third clock CLK3, and the difference between the high voltage level and the low voltage level of the fourth clock CLK4 are the same, differences of charged conditions of the plurality of pixels of the liquid crystal panel 508 are smaller. Further, subsequent operational principles of the liquid crystal display 800 are the same as those of the liquid crystal display 500, so further description thereof is omitted for simplicity.

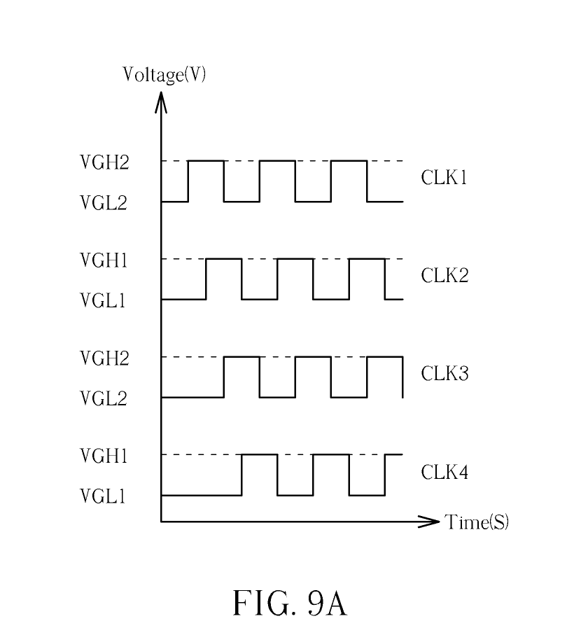

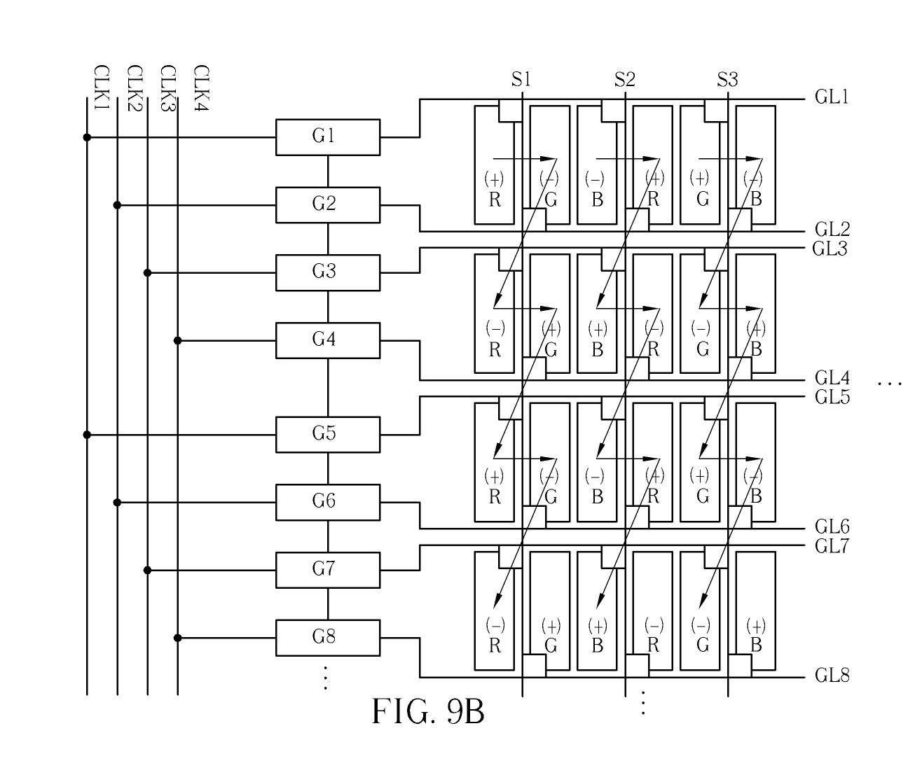

Please refer to FIG. 9A and FIG. 9B. FIG. 9A is a diagram illustrating a first clock CLK1, a second clock CLK2, a third clock CLK3, and a fourth clock CLK4 of a 1+2-line inversion liquid crystal display according to another embodiment, and FIG. 9B is a diagram illustrating pixel arrangement of the 1+2-line inversion liquid crystal display. As shown in FIG. 9A, high voltage levels of the second clock CLK2 and the fourth clock CLK4 are the first high gate voltage VGH1, high voltage levels of the first clock CLK1 and the third clock CLK3 are the second high gate voltage VGH2, low voltage levels of the second clock CLK2 and the fourth clock CLK4 are the first low gate voltage VGL1, and low voltage levels of the first clock CLK1 and the third clock CLK3 are the second low gate voltage VGL2. As shown in FIG. 9B, a polarity of a pixel opposite a polarity of a previous pixel corresponds to the gate driving units G2, G4, G6 . . . , and a polarity of a pixel the same as a polarity of a previous pixel corresponds to the gate driving units G1, G3, G5 . . . Therefore, the gate driving units G1, G5, G9 . . . correspond to the first clock CLK1, the gate driving units G3, G7, G11 . . . correspond to the third clock CLK3, the gate driving units G2, G6, G10 . . . correspond the second clock CLK2, and the gate driving units G4, G8, G12 . . . correspond to the fourth clock CLK4. Further, subsequent operational principles of the embodiment in FIG. 9A and FIG. 9B are the same as those of the liquid crystal display 800, so further description thereof is omitted for simplicity.

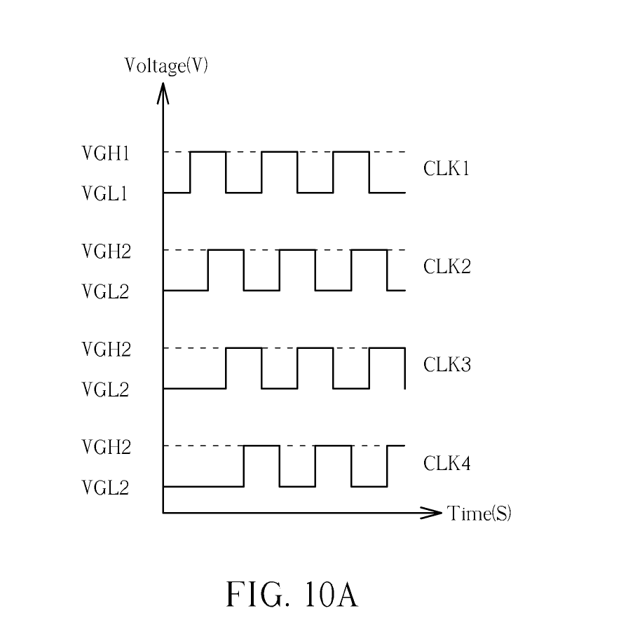

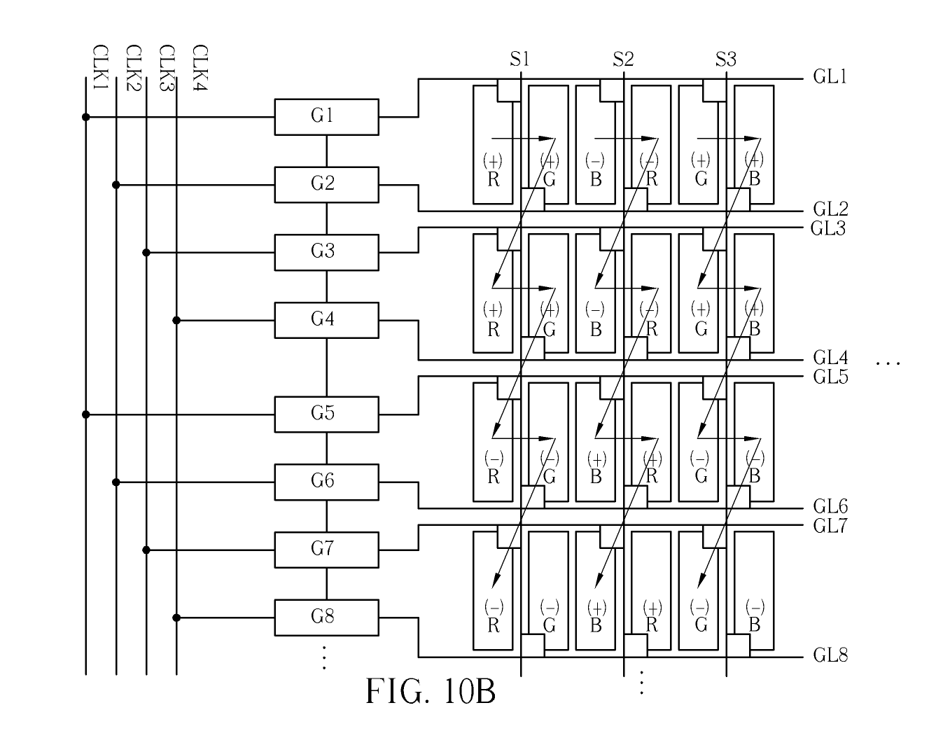

Please refer to FIG. 10A and FIG. 10B. FIG. 10A is a diagram illustrating a first clock CLK1, a second clock CLK2, a third clock CLK3, and a fourth clock CLK4 of a 4-line inversion liquid crystal display according to another embodiment, and FIG. 10B is a diagram illustrating pixel arrangement of the 4-line inversion liquid crystal display. As shown in FIG. 10A, a high voltage level of the first clock CLK1 is the first high gate voltage VGH1, high voltage levels of the second clock CLK2, the third clock CLK3, and the fourth clock CLK4 are the second high gate voltage VGH2, a low voltage level of the first clock CLK1 is the first low gate voltage VGL1, and low voltage levels of the second clock CLK2, the third clock CLK3, and the fourth clock CLK4 are the second low gate voltage VGL2. As shown in FIG. 10B, a polarity of a pixel opposite a polarity of a previous pixel corresponds to the gate driving units G1, G5, G9 . . . , and a polarity of a pixel the same as a polarity of a previous pixel corresponds to the gate driving units G2, G3, G4, G6, G7, G8 . . . . Therefore, the gate driving units G1, G5, G9 . . . correspond to the first clock CLK1, the gate driving units G2, G6, G10 . . . correspond to the second clock CLK2, the gate driving units G3, G7, G11 . . . correspond to the third clock CLK3, and the gate driving units G4, G8, G12 . . . correspond to the fourth clock CLK4. Further, subsequent operational principles of the embodiment in FIG. 10A and FIG. 10B are the same as those of the liquid crystal display 800, so further description thereof is omitted for simplicity.

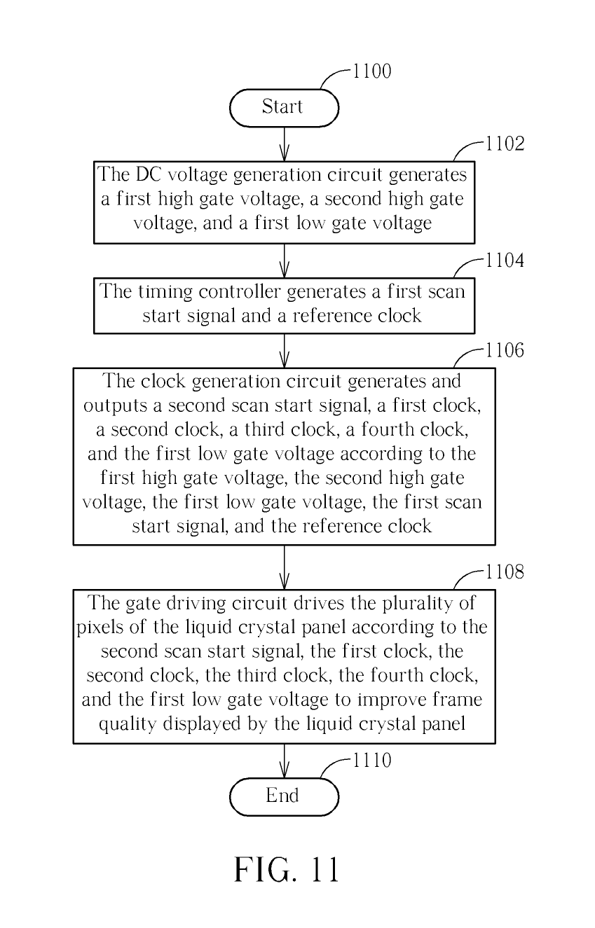

Please refer to FIG. 11. FIG. 11 is a flowchart illustrating a method of compensating gate voltages of a liquid crystal display according to another embodiment. The method in FIG. 11 is illustrated using the liquid crystal display 500 in FIG. 5. Detailed steps are as follows:

Step 1100: Start.

Step 1102: The DC voltage generation circuit 502 generates a first high gate voltage VGH1, a second high gate voltage VGH2, and a first low gate voltage VGL1.

Step 1104: The timing controller 504 generates a first scan start signal STPV and a reference clock CLKV.

Step 1106: The clock generation circuit 506 generates and outputs a second scan start signal STP, a first clock CLK1, a second clock CLK2, a third clock CLK3, a fourth clock CLK4, and the first low gate voltage VGL1 according to the first high gate voltage VGH1, the second high gate voltage VGH2, the first low gate voltage VGL1, the first scan start signal STPV, and the reference clock CLKV.

Step 1108: The gate driving circuit 5082 drives the plurality of pixels of the liquid crystal panel 508 according to the second scan start signal STP, the first clock CLK1, the second clock CLK2, the third clock CLK3, the fourth clock CLK4, and the first low gate voltage VGL1 to improve frame quality displayed by the liquid crystal panel 508.

Step 1110: End.

In Step 1102, the DC voltage generation circuit 502 generates the first high gate voltage VGH1, the second high gate voltage VGH2, and the first low gate voltage VGL1 to the clock generation circuit 506, where the first high gate voltage VHG1 is higher than the second high gate voltage VGH2. In Step 1104, the timing controller 504 generates the first scan start signal STPV and the reference clock CLKV to the clock generation circuit 506. In Step 1106, a phase of the first clock CLK1 is opposite a phase of the third clock CLK3, and a phase of the second clock CLK2 is opposite a phase of the fourth clock CLK4. In Step 1108, the gate driving circuit 5082 drives the plurality of pixels included by the liquid crystal panel 508 in the Z-type sequence. The (4n+1) ^{th} gate driving unit of a plurality of gate driving units G1 to Gm receives the first clock CLK1, the (4n+2)^{th} gate driving unit of the plurality of gate driving units G1 to Gm receives the second clock CLK2, the (4n+3)^{th} gate driving unit of the plurality of gate driving units G1 to Gm receives the third clock CLK3, and the (4n+4)^{th} gate driving unit of the plurality of gate driving units G1 to Gm receives the fourth clock CLk4. In addition, as shown in FIG. 6B, a polarity of a pixel opposite a polarity of a previous pixel corresponds to the gate driving units G1, G3, G5 . . . , and a polarity of a pixel the same as a polarity of a previous pixel corresponds to the gate driving units G2, G4, G6 . . . . The gate driving units G1, G5, G9 . . . correspond to the (4n+1)^{th} gate driving unit, the gate driving units G3, G7, G11 . . . correspond to the (4n+3)^{th} gate driving unit, the gate driving units G2, G6, G10 . . . correspond to the (4n+2)^{th} gate driving unit, and the gate driving units G4, G8, G12 . . . correspond to the (4n+4)^{th} gate driving unit, where high voltage levels of the second clock CLK2 and the fourth clock CLK4 are the second high gate voltage VGH2, high voltage levels of the first clock CLK1 and the third clock CLK3 are the first high gate voltage VGH1, and low voltage levels of the first clock CLK1, the second clock CLK2, the third clock CLK3, and the fourth clock CLK4 are the first low gate voltage VGL1. In addition, compared to the prior art, because the first high gate voltage VGH1 is higher than the second high gate voltage VGH2, differences of charged conditions of the plurality of pixels of the liquid crystal panel 508 are smaller, resulting in the frame quality displayed by the liquid crystal panel 508 being better.

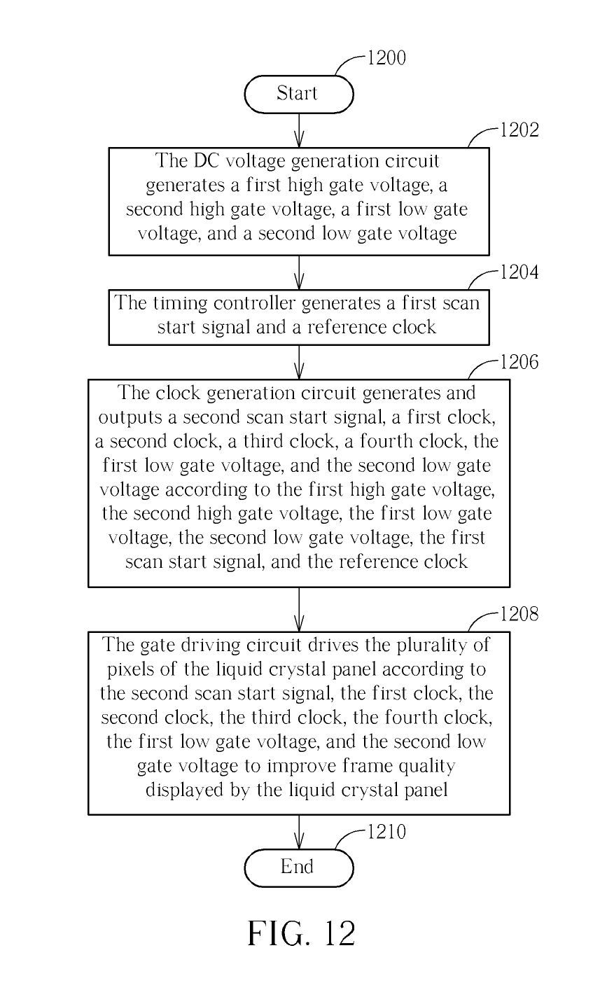

Please refer to FIG. 12. FIG. 12 is a flowchart illustrating a method of compensating gate voltages of a liquid crystal display according to another embodiment. The method in FIG. 12 is illustrated using the liquid crystal display 800 in FIG. 8A. Detailed steps are as follows:

Step 1200: Start.

Step 1202: The DC voltage generation circuit 802 generates a first high gate voltage VGH1, a second high gate voltage VGH2, a first low gate voltage VGL1, and a second low gate voltage VGL2.

Step 1204: The timing controller 504 generates a first scan start signal STPV and a reference clock CLKV.

Step 1206: The clock generation circuit 806 generates and outputs a second scan start signal STP, a first clock CLK1, a second clock CLK2, a third clock CLK3, a fourth clock CLK4, the first low gate voltage VGL1, and the second low gate voltage VGL2 according to the first high gate voltage VGH1, the second high gate voltage VGH2, the first low gate voltage VGL1, the second low gate voltage VGL2, the first scan start signal STPV, and the reference clock CLKV.

Step 1208: The gate driving circuit 5082 drives the plurality of pixels of the liquid crystal panel 508 according to the second scan start signal STP, the first clock CLK1, the second clock CLK2, the third clock CLK3, the fourth clock CLK4, the first low gate voltage VGL1, and the second low gate voltage VGL2 to improve frame quality displayed by the liquid crystal panel 508.

Step 1210: End.

A difference between the embodiment in FIG. 12 and the embodiment in FIG. 11 is that in Step 1202, the DC voltage generation circuit 802 further generates the second low gate voltage VGL2 to the clock generation circuit 806; in Step 1206 the clock generation circuit 806 generates and outputs the second scan start signal STP, the first clock CLK1, the second clock CLK2, the third clock CLK3, the fourth clock CLK4, the first low gate voltage VGL1, and the second low gate voltage VGL2 according to the first high gate voltage VGH1, the second high gate voltage VGH2, the first low gate voltage VGL1, the second low gate voltage VGL2, the first scan start signal STPV, and the reference clock CLKV; and in Step 1208, the gate driving circuit 5082 drives the plurality of pixels of the liquid crystal panel 508 according to the second scan start signal STP, the first clock CLK1, the second clock CLK2, the third clock CLK3, the fourth clock CLK4, the first low gate voltage VGL1, and the second low gate voltage VGL2, where the first low gate voltage VGL1 is higher than the second low gate voltage VGL2. In addition, in Step 1206, high voltage levels of the second clock CLK2 and the fourth clock CLK4 are the second high gate voltage VGH2, high voltage levels of the first clock CLK1 and the third clock CLK3 are the first high gate voltage VGH1, low voltage levels of the second clock CLK2 and the fourth clock CLK4 are the second low gate voltage VGL2, and low voltage levels of the first clock CLK1 and the third clock CLK3 are the first low gate voltage VGL1. In Step 1208, compared to the prior art, because a difference between the high voltage level and the low voltage level of the first clock CLK1, a difference between the high voltage level and the low voltage level of the second clock CLK2, a difference between the high voltage level and the low voltage level of the third clock CLK3, and a difference between the high voltage level and the low voltage level of the fourth clock CLK4 are the same, differences of charged conditions of the plurality of pixels of the liquid crystal panel 508 are smaller, resulting in the frame quality displayed by the liquid crystal panel 508 being better. Further, subsequent operational principles of the embodiment in FIG. 12 are the same as those of the embodiment in FIG. 11, so further description thereof is omitted for simplicity.

In addition, please refer to FIG. 9A and FIG. 9B. As shown in FIG. 9A, in another embodiment in FIG. 12, high voltage levels of the second clock CLK2 and the fourth clock CLK4 are the first high gate voltage VGH1, high voltage levels of the first clock CLK1 and the third clock CLK3 are the second high gate voltage VGH2, low voltage levels of the second clock CLK2 and the fourth clock CLK4 are the first low gate voltage VGL1, and low voltage levels of the first clock CLK1 and the third clock CLK3 are the second low gate voltage VGL2. As shown in FIG. 9B, a polarity of a pixel opposite a polarity of a previous pixel corresponds to the gate driving units G2, G4, G6 . . . , and a polarity of a pixel the same as a polarity of a previous pixel corresponds to the gate driving units G1, G3, G5 . . . . Therefore, the gate driving units G1, G5, G9 . . . correspond to the first clock CLK1, the gate driving units G3, G7, G11 . . . correspond to the third clock CLK3, the gate driving units G2, G6, G10 . . . correspond to the second clock CLK2, and the gate driving units G4, G8, G12 . . . correspond to the fourth clock CLK4.

In addition, please refer to FIG. 10A and FIG. 10B. As shown in FIG. 10A, in another embodiment in FIG. 12, high voltage level of the first clock CLK1 is the first high gate voltage VGH1, high voltage levels of the second clock CLK2, the third clock CLK3, and the fourth clock CLK4 are the second high gate voltage VGH2, low voltage level of the first clock CLK1 is the first low gate voltage VGL1, and low voltage levels of the second clock CLK2, the third clock CLK3, and the fourth clock CLK4 are the second low gate voltage VGL2. As shown in FIG. 10B, a polarity of a pixel opposite a polarity of a previous pixel corresponds to the gate driving units G1, G5, G9 . . . , and a polarity of a pixel the same as a polarity of a previous pixel corresponds to the gate driving units G2, G3, G4, G6, G7, G8 . . . Therefore, the gate driving units G1, G5, G9 . . . correspond to the first clock CLK1, the gate driving units G2, G6, G10 . . . correspond to the second clock CLK2, the gate driving units G3, G7, G11 . . . correspond to the third clock CLK3, and the gate driving units G4, G8, G12 . . . correspond to the fourth clock CLK4.

To sum up, the liquid crystal display which can compensate the gate voltages and method thereof utilize different high gate voltages to solve uneven charged conditions of the plurality of pixels of the liquid crystal panel. Compared to the prior art, because differences of charged conditions of the plurality of pixels of the liquid crystal panel are smaller, the present invention can improve the frame quality displayed by the liquid crystal panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display which can compensate gate voltages, the liquid crystal display comprising:
a direct current (DC) voltage generation circuit for generating a first high gate voltage, a second high gate voltage, and a first low gate voltage, wherein the first high gate voltage is higher than the second high gate voltage;
a timing controller for generating a first scan start signal and a reference clock;
a clock generation circuit coupled between the DC voltage generation circuit and the timing controller for generating and outputting a second scan start signal, a first clock, a second clock, a third clock, a fourth clock, and the first low gate voltage according to the first high gate voltage, the second high gate voltage, the first low gate voltage, the first scan start signal, and the reference clock; and
a liquid crystal panel comprising:
a plurality of pixels; and
a gate driving circuit coupled to the clock generation circuit, the gate driving circuit including a plurality of gate driving units, wherein the plurality of gate driving units is used for driving the plurality of pixels according to the second scan start signal, the first clock, the second clock, the third clock, the fourth clock, and the first low gate voltage to improve frame quality displayed by the liquid crystal panel, wherein a phase of the first clock is opposite a phase of the third clock, and a phase of the second clock is opposite a phase of the fourth clock;
wherein a (4n+1)^{th} gate driving unit of the plurality of gate driving units receives the first clock, a (4n+2)^{th} gate driving unit of the plurality of gate driving units receives the second clock, a (4n+3)^{th} gate driving unit of the plurality of gate driving units receives the third clock, and a (4n+4)^{th} gate driving unit of the plurality of gate driving units receives the fourth clock, wherein and n is an integer.

2. The liquid crystal display of claim 1, wherein the DC voltage generation circuit, the timing controller, and the clock generation circuit are located on a printed circuit board.

3. The liquid crystal display of claim 1, wherein high voltage levels of the second clock and the fourth clock are the second high gate voltage, high voltage levels of the first clock and the third clock are the first high gate voltage, and low voltage levels of the first clock, the second clock, the third clock, and the fourth clock are the first low gate voltage.

4. The liquid crystal display of claim 1, wherein the DC voltage generation circuit further generates a second low gate voltage to the clock generation circuit, and the first low gate voltage is higher than the second low gate voltage.

5. The liquid crystal display of claim 4, wherein high voltage levels of the second clock and the fourth clock are the second high gate voltage, high voltage levels of the first clock and the third clock are the first high gate voltage, low voltage levels of the second clock and the fourth clock are the second low gate voltage, and low voltage levels of the first clock and the third clock are the first low gate voltage.

6. The liquid crystal display of claim 4, wherein high voltage levels of the second clock and the fourth clock are the first high gate voltage, high voltage levels of the first clock and the third clock are the second high gate voltage, low voltage levels of the second clock and the fourth clock are the first low gate voltage, and low voltage levels of the first clock and the third clock are the second low gate voltage.

7. The liquid crystal display of claim 4, wherein high voltage levels of the second clock, the third clock, and the fourth clock are the second high gate voltage, a high voltage level of the first clock is the first high gate voltage, low voltage levels of the second clock, the third clock, and the fourth clock are the second low gate voltage, and a low voltage level of the first clock is the first low gate voltage.

8. The liquid crystal display of claim 1, further comprising:
a source driving circuit for charging a pixel when a thin film transistor coupled to the pixel is turned on.

9. A method of compensating gate voltages of a liquid crystal display, the method comprising:
a DC voltage generation circuit generating a first high gate voltage, a second high gate voltage, and a first low gate voltage, wherein the first high gate voltage is higher than the second high gate voltage;
a timing controller generating a first scan start signal and a reference clock;
a clock generation circuit generating and outputting a second scan start signal, a first clock, a second clock, a third clock, a fourth clock, and the first low gate voltage according to the first high gate voltage, the second high gate voltage, the first low gate voltage, the first scan start signal, and the reference clock; and
driving a plurality of pixels included by a liquid crystal panel to improve frame quality displayed by the liquid crystal panel according to the second scan start signal, the first clock, the second clock, the third clock, the fourth clock, and the first low gate voltage, wherein a phase of the first clock is opposite a phase of the third clock, and a phase of the second clock is opposite a phase of the fourth clock;
wherein a (4n+l)^{th} gate driving unit of the plurality of gate driving units of the liquid crystal panel receives the first clock, a (4n+2)^{th} gate driving unit of the plurality of gate driving units receives the second clock, a (4n+3) ^{th} gate driving unit of the plurality of gate driving units receives the third clock, and a (4n+4)^{th} gate driving unit of the plurality of gate driving units receives the fourth clock, wherein n≧10 and n is an integer.

10. The method of claim 9, wherein high voltage levels of the second clock and the fourth clock are the second high gate voltage, high voltage levels of the first clock and the third clock are the first high gate voltage, and low voltage levels of the first clock, the second clock, the third clock, the fourth clock are the first low gate voltage.

11. The method of claim 9, further comprising:
the DC voltage generation circuit generating a second low gate voltage to the clock generation circuit, wherein the first low gate voltage is higher than the second low gate voltage.

12. The method of claim 11, wherein high voltage levels of the second clock and the fourth clock are the second high gate voltage, high voltage levels of the first clock and the third clock are the first high gate voltage, low voltage levels of the second clock and the fourth clock are the second low gate voltage, and low voltage levels of the first clock and the third clock are the first low gate voltage.

13. The method of claim 11, wherein high voltage levels of the second clock and the fourth clock are the first high gate voltage, high voltage levels of the first clock and the third clock are the second high gate voltage, low voltage levels of the second clock and the fourth clock are the first low gate voltage, and low voltage levels of the first clock and the third clock are the second low gate voltage.

14. The method of claim 11, wherein high voltage levels of the second clock, the third clock, and the fourth clock are the second high gate voltage, a high voltage level of the first clock is the first high gate voltage, low voltage levels of the second clock, the third clock, and the fourth clock are the second low gate voltage, and a low voltage level of the first clock is the first low gate voltage.
